(19) United States
(12) Patent Application Publication
(10) Pub. No.: US 2011/0299130 A1
(43) Pub. Date: Dec. 8, 2011

(54) CLOUD COMPUTING SYSTEM, DOCUMENT PROCESSING METHOD, AND STORAGE MEDIUM

(75) Inventor: Yuki Ito, Kawasaki-shi (JP)

(73) Assignee: CANON KABUSHIKI KAISHA, Tokyo (JP)

(21) Appl. No.: 13/109,483

(22) Filed: May 17, 2011

(30) Foreign Application Priority Data
Jun. 4, 2010 (JP) 2010-128401

(51) Int. Cl. H04N 1/32

(52) U.S. Cl. 358/442

(57) ABSTRACT

A scan system includes a request reception unit that stores a message corresponding to a document processing job in a queue in response to the receipt of an execution request for the document processing job from an image forming apparatus; and a back-end processing unit that makes an acquisition request for the message with respect to the queue at a regular interval, acquires the message, executes a document processing job corresponding to the acquired message, and stores the execution result of the job. Before the image forming apparatus transmits an execution request for a document processing job to the request reception unit, the back-end processing unit acquires information indicating a location at which the execution result of the acquired job is stored, and the request reception unit causes the image forming apparatus to display information indicating a location at which the execution result of the acquired job is stored.

### BACKGROUND OF THE INVENTION

1. Field of the Invention

The present invention relates to a cloud computing system, a document processing method, and a storage medium.

2. Description of the Related Art

In recent years, a document management system utilizing Internet technology has become popular. The document management system performs document management by storing a document, which has been scanned by an image forming apparatus, in a storage server. For example, Japanese Patent Laid-Open No. 2007-028184 discloses a document registration system having an MFP device, an option service, and a Web storage server that are connected to a network. In the document registration system, an image forming apparatus including a device browser communicates with the Web storage server. When a user specifies processing to be applied to a scan document and storage location from the image forming apparatus, processing specified by the option service is performed, and the scan document is stored in the Web storage server.

In recent years, technologies such as the cloud computing system or SaaS (Software as a Service) are being utilized as a form of performing various processes on the server computer side. In cloud computing, many computing resources are utilized to execute data conversion and data processing in a distributed manner, whereby requests made by many clients can be concurrently processed.

### SUMMARY OF THE INVENTION

The cloud computing system of the present invention reports the storage location of the document processing result to an image forming apparatus before a document processing execution request is received from the image forming apparatus.

According to an aspect of the present invention, a cloud computing system is provided that includes a request reception unit that stores a message corresponding to a document processing job in a storage unit in response to the receipt of an execution request for the document processing job from an image forming apparatus; and a document processing unit that makes an acquisition request for the message to the storage unit at a regular interval, acquires the message, and stores job data that corresponds to the acquired message; wherein, before the image forming apparatus transmits an execution request for a document processing job to the request reception unit, the document processing unit acquires information indicating a location at which the job data is stored, and the request reception unit generates screen information for displaying information indicating the acquired location at which the job data is stored on the image forming apparatus.

Further features of the present invention will become apparent from the following description of exemplary embodiments with reference to the attached drawings.

### BRIEF DESCRIPTION OF THE DRAWINGS

FIG. 1 is a diagram illustrating an example of the system configuration of the present embodiment.

FIGS. 2A and 2B are diagrams illustrating examples of the hardware configuration of an apparatus used in the system shown in FIG. 1.

FIGS. 3A and 3B are diagrams illustrating the functions of a scan system, a storage, and an image forming apparatus.

FIG. 4A is a diagram illustrating an example of a service table.

FIG. 4B is a diagram illustrating an example of a storage table.

FIG. 5 is a sequence diagram illustrating document processing of the first embodiment.

FIG. 6 is a sequence diagram illustrating document processing of the first embodiment.

FIG. 7 is a sequence diagram illustrating document processing of the first embodiment.

FIGS. 8A and 8B are diagrams illustrating examples of a screen to be displayed on a device browser.

FIG. 9A is a diagram illustrating an example of another scan service selection screen.

FIG. 9B is a diagram illustrating an example of another storage selection screen.

FIG. 10 is a flowchart illustrating an example of operation processing performed by a request reception unit.

FIG. 11 is a flowchart illustrating an example of operation processing performed by a back-end processing unit.

FIG. 12 is a diagram illustrating an example of a start screen to be displayed on a device browser.

FIG. 13 is a sequence diagram illustrating document processing of a second embodiment.

### DESCRIPTION OF THE EMBODIMENTS

In a scan system utilizing a cloud computing, a user cannot normally know the physical location of the scan system. A user can utilize the scan system without considering the physical location. However, when a scan system is provided at a region such as the EU where the storage location for confidential information relating to personal information is restricted to specific countries, the following problems may occur. Specifically, document processing may undesirably be performed without a user being aware in a country or a region where the storage of a confidential document is legally restricted. However, conventionally, there has been no system that reports information indicating a location at which the document processing result is stored to an image forming apparatus before the image forming apparatus operated by a user makes an execution request for document processing. Also, there has been no system that reports information indicating a location at which a processing apparatus for executing document processing is provided to an image forming apparatus before the image forming apparatus makes an execution request for document processing. According to the system of the present embodiment to be described below, such problems can be solved.

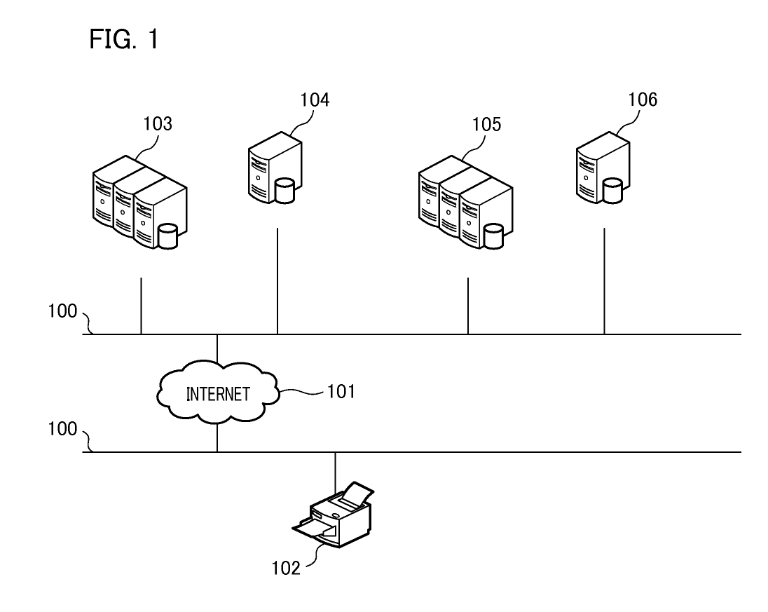

FIG. 1 is a diagram illustrating an example of the system configuration of the present embodiment. The system shown in FIG. 1 includes scan systems 103 and 105, storage 104 and 106, and an image forming apparatus 102. The scan systems 103 and 105 and the storage 104 and 106 are connected to each other via a network 100. The image forming apparatus 102 is connected to the scan systems 103 and 105, and the storage 104 and 106 via the network 100 and the Internet 101. The scan system 103 and the storage 104 are provided in Asia. The scan system 105 and the storage 106 are provided in the EU. Each scan system includes a server group including a plurality of servers.

The image forming apparatus 102 transmits a document processing request to a scan system. An exemplary document processing request is a service start request or a service execution request. Document processing is, for example, processing for converting image data such as a bit map or the like, which has been generated by the image forming apparatus 102 by reading a document, into a PDF format. A service start request is a request for starting a service, that is, a request for generating a document processing job, where the request is made to a scan system. A service execution request is a request for executing a document processing job. The image forming apparatus 102 is provided in a local area to which access from the outside is limited. The local area is blocked from the area, at which the scan systems are arranged, by firewall.

Each of the scan systems 103 and 105 is the cloud computing system of the present embodiment. The scan system receives a document processing request from the image forming apparatus 102, and executes document processing in response to the request. For example, the scan system converts image data such as a bit map or the like into a PDF format in response to the service execution request received from the image forming apparatus 102, and stores the converted image data as print data in storage.

In the present embodiment, the scan systems are provided in a cloud. The cloud refers to a region in which a server group is arranged in a cloud computing environment. In the cloud computing environment, a user utilizes computer processing as a service via network. Access to the inside of a firewall cannot be made by a request that has been made from a scan system provided in a cloud. Thus, the scan system communicates with the image forming apparatus 102 by returning a response to the request from the image forming apparatus 102. The document processing method of the present embodiment is realized by the scan systems shown in FIG. 1. Also, the computer program of the present embodiment causes a computer to execute the document processing method. The storage 104 stores a document processing result obtained by the scan system 103. The storage 106 stores a document processing result obtained by the scan system 105.

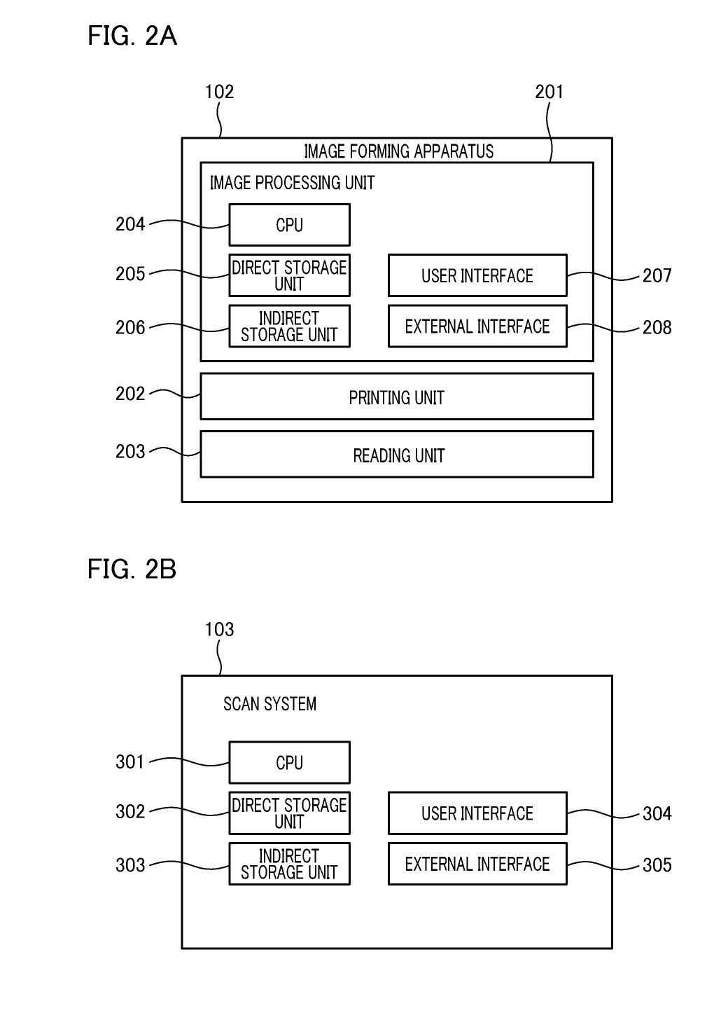

Each of FIGS. 2A and 2B is a diagram illustrating an example of the hardware configuration of the apparatus constituting the system shown in FIG. 1. FIG. 2A is a diagram illustrating an example of the hardware configuration of the image forming apparatus 102. The image forming apparatus 102 includes an image processing unit 201, a printing unit 202, and a reading unit 203. The reading unit 203 performs document (original document) read processing. The image processing unit 201 generates image data based on the document read processing result obtained by the reading unit 203.

The image processing unit 201 makes a service start request to the scan system. Also, the image processing unit 201 acquires information, which includes information indicating a location at which storage that stores the document processing result, i.e., print data is provided, from the scan system that has received the service start request. A location at which storage is provided is, for example, a country or a region in which the storage is provided. Also, the image processing unit 201 acquires information, which includes information indicating a location at which a processing unit for executing document processing is provided, from the scan system that has received the service start request. A location at which a processing unit for executing document processing is provided is, for example, a country or a region in which the processing unit is provided.

Further, the image processing unit 201 transmits a service execution request including the generated image data to the scan system. The image processing unit 201 also has a function that accesses storage to acquire print data. The printing unit 202 prints print data.

The image processing unit 201 includes a CPU (Central Processing Unit) 204, a direct storage unit 205, an indirect storage unit 206, a user interface 207, and an external interface 208. The CPU 204 executes a predetermined program, and directs various types of control of an image processing apparatus 104. The direct storage unit 205 is a working memory to be used when the CPU 204 executes a program. The program executed by the CPU 204 is loaded into the direct storage unit 205. The direct storage unit 205 is realized by RAM (Random Access Memory). The indirect storage unit 206 stores various programs including an application program in advance. The various programs stored in the indirect storage unit 206 are moved to the direct storage unit 205 when the CPU 204 executes the programs. The indirect storage unit 206 is realized by an SSD (Solid State Drive) or an HDD (Hard Disc Drive). Note that the CPU 204 may be a multiprocessor. In the present embodiment, scan software is operated as an application program. Scan software reads image data from the reading unit 203, and transmits the image data to an external device using a communication protocol such as HTTP (Hyper Text Transfer Protocol). As described above, the control of the image forming apparatus 102 may be realized by executing an application program.

The user interface 207 receives a processing request from a user. The user interface 207 receives a signal corresponding to an instruction that has been input by a user via, for example, a keyboard, a mouse, or the like. The external interface 208 can receive/transmit data from/to an external device. For example, an external device includes an external storage device such as an external HDD, an external USB memory, or the like, or a separate body device such as a separate body host computer, image forming apparatus, or the like that is connected via network. The image forming apparatus 102 can communicate with the respective scan systems and storage via the network 100 and the Internet 101.

FIG. 2B is a diagram illustrating an example of the hardware configuration of a scan system and a storage. In FIG. 2B, a description will be given by taking an example of the hardware configuration of the scan system 103. The hardware configuration of the scan system 105 and the respective storage is the same as that of the scan system 103 shown in FIG. 2B.

The scan system 103 includes a CPU 301, a direct storage unit 302, an indirect storage unit 303, a user interface 304, and an external interface 305. The CPU 301 is a unit that executes a predetermined program and directs various types of control of the scan system 103. The direct storage unit 302 is a working memory to be used when the CPU 301 executes a program. A program executed by the CPU 301 is loaded into the direct storage unit 302. The direct storage unit 302 is constituted by RAM. The indirect storage unit 303 stores various programs including application programs and an OS (Operating System) in advance. The various programs stored in the indirect storage unit 303 are moved to the direct storage unit 302 when the CPU 301 executes the programs. The indirect storage unit 303 is constituted by a ROM or an HDD. The user interface 304 receives a processing request from a user. For example, the user interface 304 receives a signal corresponding to an instruction that has been input by a user via, for example, a keyboard, a mouse, or the like. The external interface 305 is connected to the network 100, and can communicate with another device that is connected to the network 100.

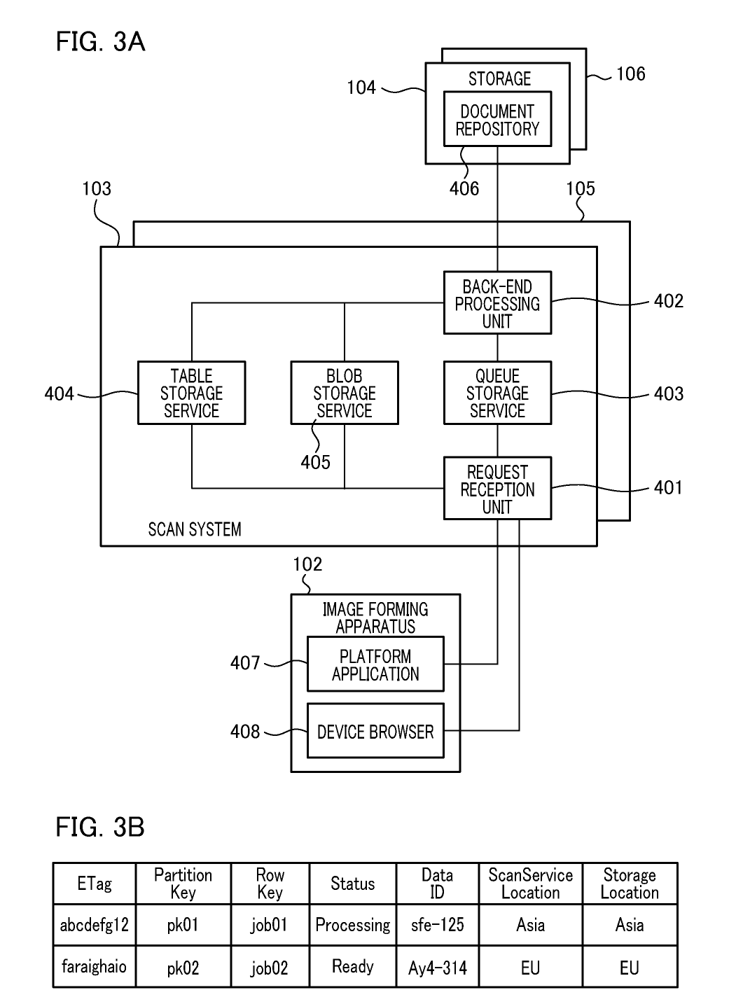

FIGS. 3A and 3B are diagrams illustrating the functions of a scan system, storage, and an image forming apparatus. The scan system 103 and the scan system 105 shown in FIG. 3A have the same configuration. Also, the storage 104 and the storage 106 shown in FIG. 3A have the same configuration.

The scan system 103 includes a request reception unit 401, a back-end processing unit 402, a queue storage service 403, a table storage service 404, and a blob storage service 405. Each of the request reception unit 401, the back-end processing unit 402, the queue storage service 403, the table storage service 404, and the blob storage service 405 includes one or a plurality of VMs (Virtual Machines). VM is a virtual server.

The request reception unit 401 functions as a request reception unit that receives a document processing request which has been transmitted from a platform application 407 for the image forming apparatus 102. When the request reception unit 401 receives a service start request from the platform application 407, the request reception unit 401 generates a document processing job. The request reception unit 401 provides instructions to the table storage service 404, and causes the table storage service 404 to add information (job information) regarding the document processing job to a job table. Job information includes at least a job ID that is job identification information.

Also, the request reception unit 401 provides instructions to the queue storage service 403, and causes the queue storage service 403 to store a message including at least a job ID in a queue that is a storage unit provided in the queue storage service 403. More specifically, the queue storage service 403 stores a message including correspondence information between a message ID and a job ID in a queue. The message ID is identification information about a message. A message ID is associated with a message type. The message type indicates processing content that is required for the back-end processing unit 402. A message type associated with a message ID is, for example, “document processing start” (scan service start). The document processing start indicates the start of processing for acquiring information (storage location information) indicating a location at which the execution result of a document processing job is stored, and information (execution location information) indicating a location at which a scan system for executing a job is arranged.

The request reception unit 401 receives a job information acquisition request from the platform application 407 of the image forming apparatus 102. The job information acquisition request is a request for the acquisition of job information. The request reception unit 401 returns job information corresponding to the job information acquisition request to the image forming apparatus 102. As is described below, the back-end processing unit 402 updates job information using information (storage location information) indicating a location at which the execution result of a document processing job is stored and information (execution location information) indicating a location at which a processing unit for executing a job is arranged. The job information update processing is executed before the image forming apparatus 102 makes a service execution request to the scan system 103. With this arrangement, the scan system 103 can report storage location information and execution location information to the image forming apparatus 102 prior to the actual execution of document processing.

In response to the receipt of an execution request for a document processing job from the image forming apparatus 102, the request reception unit 401 stores a message corresponding to the document processing job in a queue. More specifically, when the request reception unit 401 receives a service execution request from the platform application 407, the request reception unit 401 stores image data included in the received service execution request in the blob storage service 405 provided in the scan system for executing document processing. Also, the request reception unit 401 provides instructions to the queue storage service 403 provided in the scan system for executing document processing, and causes the queue storage service 403 to add a message, which includes information required for executing a document processing job, in a queue. The message includes at least a message ID. The message type associated with the message ID indicates “document processing execution”. The message type “document processing execution” indicates to execute document processing. The queue storage service 403 has a function to perform data communication between the request reception unit 401 and the back-end processing unit 402 in an asynchronous manner. The queue storage service 403 stores a message in a queue in accordance with the instructions given by the request reception unit 401.

The back-end processing unit 402 functions as a document processing unit that acquires a message by making an acquisition request for the massage to a queue at a regular interval, executes a document processing job corresponding to the acquired message, and stores the execution result (job data) of the job. The back-end processing unit 402 acquires a message from a queue, and executes processing in accordance with the message type that is associated with the message ID included in the acquired message. For example, when the message type indicates “document processing start”, the back-end processing unit 402 acquires storage location information and execution location information. The back-end processing unit 402 updates job information in the table storage service 404 using the acquired storage location information and execution location information. When a job information acquisition request is received from the image forming apparatus 102, the request reception unit 401 acquires and returns the updated job information. With this arrangement, information indicating a location at which the execution result of a document processing job is stored and information indicating a location at which a scan system for executing a job is arranged can be reported to the image forming apparatus 102.

Also, when the message type is “document processing execution” (e.g., scan service execution), the back-end processing unit 402 acquires image data from the blob storage service 405 based on the blob URI included in the message. The blob URI is a URI that is managed by the blob storage service 405 and indicates a storage location of image data. The back-end processing unit 402 converts the acquired image data to thereby generate print data. Then, the back-end processing unit 402 refers to information (storage ID) that is included in the message and indicates a document repository 406 in which print data is stored, and stores print data in the document repository 406. The table storage service 404 includes a job table, and manages job information on the job table. The blob storage service 405 stores image data in accordance with the instructions given by the request reception unit 401.

The storage 104 includes the document repository 406. The document repository 406 is realized by the indirect storage unit 303 shown in FIG. 2B. The document repository 406 stores the document processing result (print data) obtained by the back-end processing unit 402 provided in the scan system 103.

The image forming apparatus 102 includes a platform application 407 and a device browser 408. The platform application 407 provides the service of scan software. Also, the platform application 407 makes a service start request, a service execution request, or a job information acquisition request to the request reception unit 401 provided in the scan system 103. The device browser 408 displays information stored in the image forming apparatus 102 or information received from the scan system 103. For example, the device browser 408 displays the storage location information and the execution location information, which are included in the job information received from the scan system 103 on a screen. The device browser 408 is, for example, a Web browser.

FIG. 3B is a diagram illustrating an example of a job table. The job table stores job information. Job information is generated for each service. An exemplary service is processing such as image PDF conversion, image compression, or the like. Job information includes ETag, Partition Key, Row Key, Status, Data ID, Scan Service Location, and Storage Location. ETag is a value that is automatically set by the table storage service 404. When row data is updated, a unique value is written as ETag. When the table storage service 404 updates job information and the value of the ETag upon acquisition of job information to be updated is different from the value of the ETag upon update of the job information, another process can identify that job information has been updated.

Each of Partition Key and Row Key is the ID (job ID) for uniquely identifying the row of the job table. Status holds the status of the entire job. The job status is designated as “Ready”, “Confirm”, “Processing”, “Success”, and “Failure” depending on the processing status of a job. The job status “Ready” indicates the state of a job from the addition of job information to the job table by the table storage service 404 in accordance with the instructions given by the request reception unit 401 to just before the update of job information by the back-end processing unit 402 using execution location information and storage location information. The job status “Confirm” indicates the state of a job from the setting of execution location information and storage location information to the job information managed by the table storage service 404 by the back-end processing unit 402 to the start of job processing by the back-end processing unit 402. The job status “Processing” indicates the state of a job from the start of job processing by the back-end processing unit 402 to the completion of execution of all of the processing defined in the job or to the failure of processing in the course of processing. The job status “Success” indicates the state where the back-end processing unit 402 has executed all of the processing defined in a job and all of the processing has been successful. The job status “Failure” indicates the state where the back-end processing unit 402 has failed in the processing defined in a job as a result of execution or the state where it is determined prior to the execution of processing that the quality of service does not satisfy a certain reference.

Data ID is the ID of data (image data) that is associated with a job. Image data is stored in the blob storage service 405. Scan Service Location indicates execution location information. The back-end processing unit 402 acquires execution location information using a known service API.

Storage Location indicates storage location information. The back-end processing unit 402 confirms storage that stores the document processing result, and acquires the location of the storage (the document repository 406 provided therein) from the service API. When the back-end processing unit 402 cannot acquire storage location information, “None” is, for example, set to the Storage Location of job information.

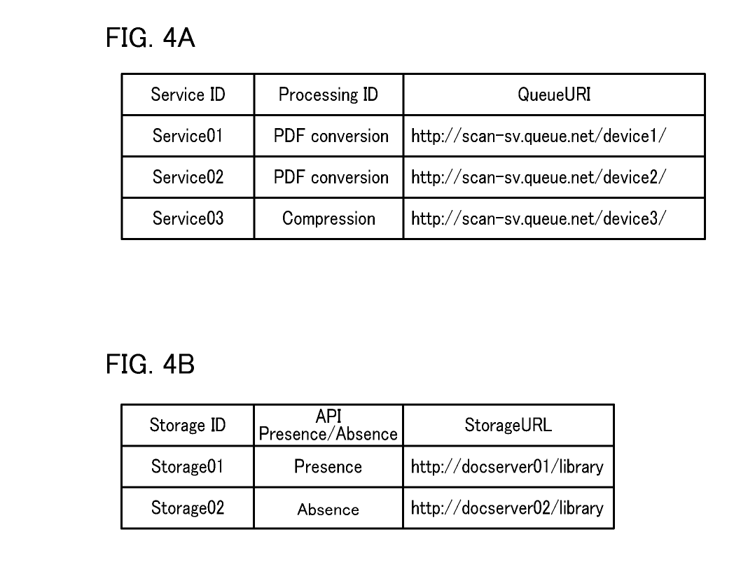

FIG. 4A is a diagram illustrating an example of a service table. The service table is provided in the request reception unit 401. The service table holds correspondence information among service, processing, and the URI of the queue storage service 403 that executes the processing. Service ID is an ID for uniquely identifying a service. Processing ID is an ID for uniquely identifying processing corresponding to a service. For example, PDF conversion or compression is set as a processing ID. Queue URI indicates the URI of the queue storage service 403. Thus, Queue URI corresponds to a scan system for executing document processing. In the present embodiment, scan systems that correspond to the processing ID of PDF conversion shown in FIG. 4A are the scan system 103 that is provided in Asia and the scan system 105 that is provided in the EU. The request reception unit 401 transmits a message to the Queue URI of the queue storage service 403 in the scan system that corresponds to the processing ID.

FIG. 4B is a diagram illustrating an example of a storage table. The storage table is provided in the back-end processing unit 402. Storage ID is an ID for uniquely identifying the row of the storage table. API presence/absence indicates whether or not the service API for acquiring storage location information is present. Storage URL indicates the URL for storage. The back-end processing unit 402 refers to the storage table, and recognizes a Storage URL that corresponds to the Storage ID which matches the storage location ID included in the message acquired from the queue storage service 403. Then, the back-end processing unit 402 stores the document processing result, i.e., print data in storage that corresponds to the recognized Storage URL.

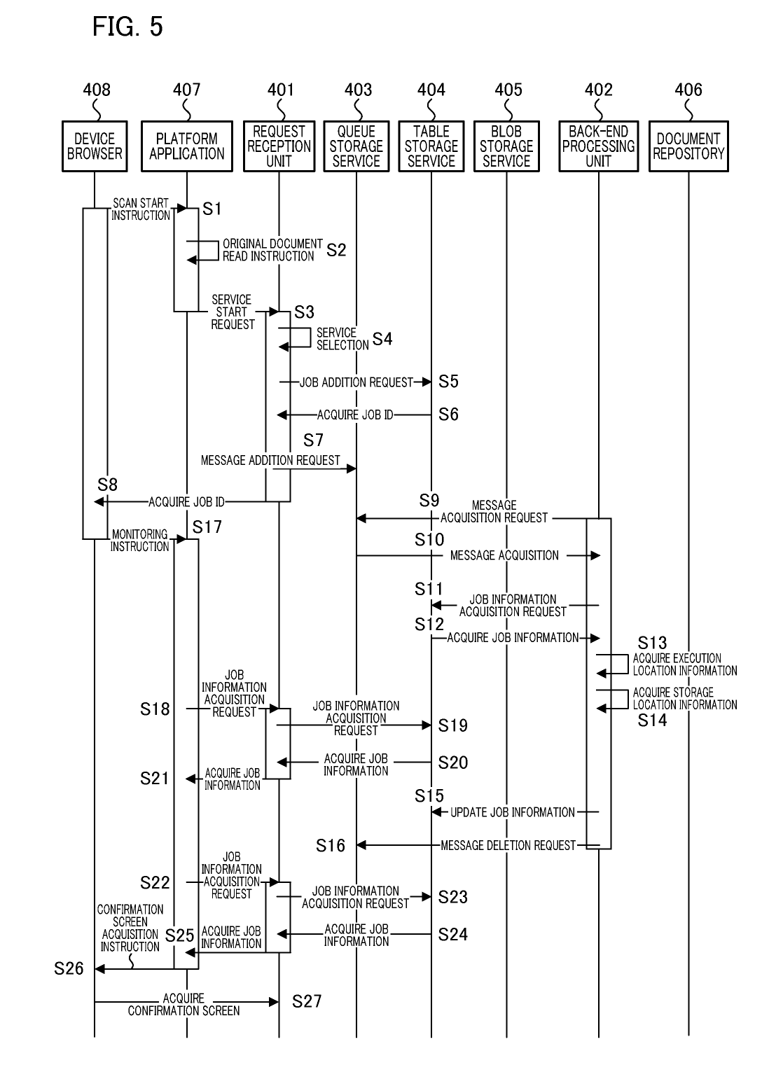

Each of FIGS. 5 to 7 is a sequence diagram illustrating document processing of the first embodiment. The device browser 408 of the image forming apparatus 102 communicates with a scan application that operates in the request reception unit 401 and performs scan processing in accordance with a user's operation.

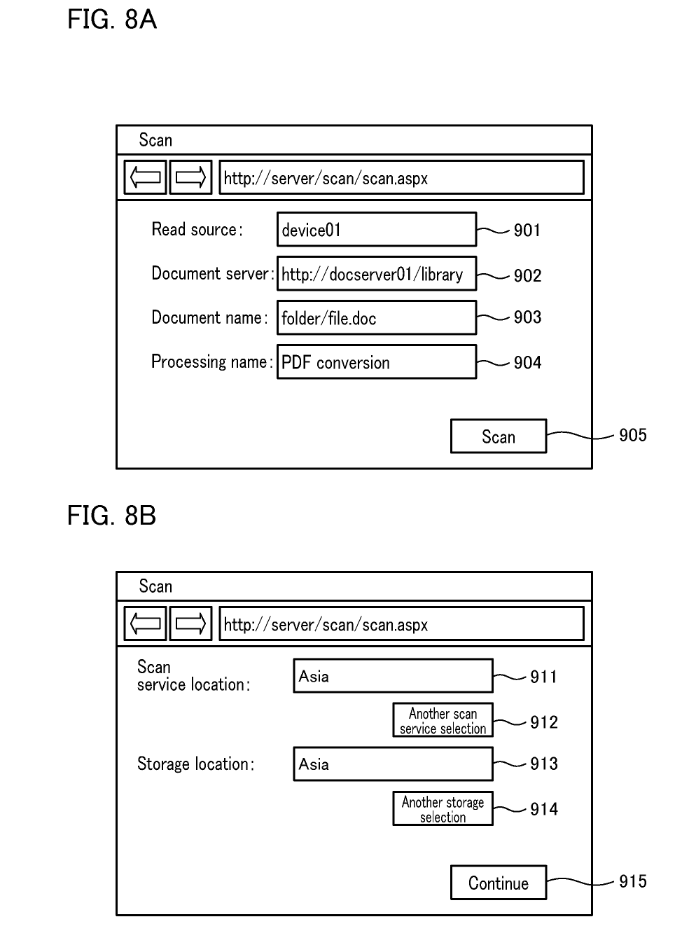

FIG. 8A is a diagram illustrating an example of a screen to be displayed on a device browser by a scan application. Information to be selected is displayed on the screen. A read source 901 on the screen displays the device ID that serves as the identification information of the image forming apparatus 102 currently operated by a user. A document server 902 displays the URL of a server in which print data is stored. A user of the image forming apparatus 102 inputs the URL of a server in which print data is stored. Note that the URL may be embedded in the program of a scan application that operates in the request reception unit 401 to thereby be displayed in association with the processing name. A document name 903 displays the name of a document that corresponds to print data to be stored in the server. When a user inputs the name of a document, a document corresponding to the name is selected. A processing name 904 displays the processing ID that indicates processing content to be applied to the scanned document. When a user inputs the processing ID, the processing ID is selected. When a user pushes a scan button 905, a series of scan sequences to be described below is executed.

In FIG. 5, when the scan button 905 (see FIG. 8A) of the image forming apparatus 102 is pushed, the device browser 408 provides a scan start instruction to the platform application 407 (step S1). The scan start instruction includes a document name, a device ID, and a processing ID as parameters.

The platform application 407 that has received the scan start instruction provides an original document read instruction to the reading unit 203 (step S2), and receives the original document read processing result, i.e., image data. The platform application 407 temporarily stores image data in the indirect storage unit 206.

Next, the platform application 407 makes a service start request to the request reception unit 401 (step S3). The service start request includes a document name, a device ID, and a processing ID. In the present embodiment, the processing ID indicates PDF conversion. Next, the request reception unit 401 performs service selection (step S4). More specifically, the request reception unit 401 refers to the service table (see FIG. 4A), and recognizes the Queue URI, which corresponds to the processing ID included in the service start request, of the scan system. The request reception unit 401 selects a service that corresponds to the recognized Queue URI. In the present embodiment, the Queue URIs that correspond to the processing ID of PDF conversion correspond to the scan system 103 provided in Asia and the scan system 105 provided in the EU. As described above, when a plurality of the Queue URIs, which corresponds to the processing ID, of the scan system is present, the request reception unit 401 performs the following processing for all of the corresponding scan systems.

The request reception unit 401 makes a job addition request to the job table provided in the table storage service 404 of the corresponding scan system (step S5). The job addition request is a request for adding job information. The table storage service 404 generates a job, adds job information to the job table, and returns the job ID to the request reception unit 401 (step S6). By means of the processes in steps S5 and S6, job information is generated for each service.

Next, the request reception unit 401 makes a message addition request to the queue storage service 403 (step S7). The message addition request is a request for adding a message. The message addition request includes a job ID. Also, the message addition request includes the message ID indicating “scan service start” as the message type. The queue storage service 403 that has received the message addition request performs message addition processing. More specifically, the queue storage service 403 stores a message including correspondence information between the message ID and the job ID in a queue. Next, the request reception unit 401 returns the job ID to the device browser 408 (step S8).

On the other hand, the back-end processing unit 402 makes a message acquisition request to the queue storage service 403 at a regular interval (step S9). The message acquisition request is a request for the acquisition of a message in a queue. The back-end processing unit 402 acquires a message from the queue storage service 403 that has responded to the message acquisition request (step S10). The message includes a message ID and a job ID. Next, the back-end processing unit 402 makes a job information acquisition request to the table storage service 404 (step S11). The job information acquisition request is a request for the acquisition of job information. The job information acquisition request includes a job ID. The table storage service 404 acquires the job information corresponding to the job ID from the job table (step S12), and returns the job information to the back-end processing unit 402.

Based on the job information acquired from the table storage service 404, the back-end processing unit 402 utilizes the service API for acquiring execution location information to thereby acquire execution location information (step S13). Also, the back-end processing unit 402 refers to the storage table (see FIG. 4B), and confirms the presence/absence of an API for acquiring storage location information. When the API for acquiring storage location information is present, the back-end processing unit 402 utilizes the API to thereby acquire storage location information (step S14). The back-end processing unit 402 provides instructions to the table storage service 404, and causes the table storage service 404 to update the job information in the job table using execution location information and storage location information which have been acquired (step S15). When the back-end processing unit cannot acquire execution location information and storage location information, the table storage service 404 sets the Scan Service Location and the Storage Location on the job table to “None”.

The table storage service 404 stores execution location information and storage location information in the job information to be updated, and sets “Confirm” in the Status on the job table. Next, the back-end processing unit 402 makes a message deletion request to the queue storage service 403 (step S16). The message deletion request is a request for deleting a message from a queue. The message deletion request includes a message ID. The queue storage service 403 deletes a message that corresponds to the message ID included in the message deletion request. With this arrangement, a message that corresponds to the processing performed by the back-end processing unit 402 (in this example, acquisition processing for acquiring an execution location and a storage location) is deleted from a queue, whereby re-execution processing caused by a timeout is not performed.

On the other hand, when the device browser 408 acquires a job ID from the request reception unit 401, the device browser 408 provides a monitoring instruction to the platform application 407 (step S17). The monitoring instruction is a request for executing job information acquisition processing. The monitoring instruction includes a job ID as a parameter. Next, the platform application 407 makes a job information acquisition request to the request reception unit 401 (step S18). The job information acquisition request includes a job ID and a device ID as parameters. The request reception unit 401 makes a job information acquisition request to the table storage service 404 (step S19). The request reception unit 401 specifies the job ID, which is included in the job information acquisition request received from the platform application 407 in step S18, as an argument of the job information acquisition request and passes it to the table storage service 404. The table storage service 404 searches the job information that matches the job ID specified from the job table, and responds with the job information to the request reception unit 401 (step S20). Next, the request reception unit 401 refers to the Status of job information, and determines whether the job status is in the “Ready” or “Confirm” state. In the present embodiment, the job status at the moment when the request reception unit 401 has received a response in step S20 is in the “Ready” state. The request reception unit 401 transmits job information including the job status to the platform application 407 (step S21).

The platform application 407 makes a job information acquisition request to the request reception unit 401 repeatedly unit print data can be acquired, and acquires job information from the table storage service 404 (steps S22 to S24). The job information acquisition request in step S22 includes a device ID and a job ID. The job information acquisition request in step S23 includes a job ID. In the present embodiment, the job information that has been acquired by the request reception unit 401 in step S24 is the job information that has been updated in step S15. In other words, the job information includes storage location information and execution location information. Also, the job status indicated by the job information is in the “Confirm” state. The request reception unit 401 transmits the job information including the job status acquired in step S24 to the platform application 407 (step S25).

The platform application 407 confirms that the job status corresponding to the job information received from the request reception unit 401 is in the “Confirm” state, and provides a confirmation screen acquisition instruction to the device browser 408 (step S26). The confirmation screen acquisition instruction is an instruction for acquiring a confirmation screen of the request reception unit 401. The confirmation screen is screen information to be generated by the request reception unit 401. Then, the device browser 408 acquires the confirmation screen from the request reception unit 401 and displays the confirmation screen (step S27).

FIG. 8B is a diagram illustrating an example of a confirmation screen to be displayed on the device browser 408. A scan application that operates in the request reception unit 401 generates the confirmation screen. A scan service location 911 corresponds to the execution location information included in the job information acquired by the request reception unit 401. In this example, the scan service location 911 displays Asia. When the back-end processing unit 402 cannot acquire execution location information in step S13 shown in FIG. 5, Scan Service Location of the job information is set to “None”. Thus, in this case, the device browser 408 does not display execution location information. Also, when the back-end processing unit 402 cannot acquire storage location information in step S14 shown in FIG. 5, Storage Location of the job information is set to “None”. Thus, in this case, the device browser 408 does not display storage location information.

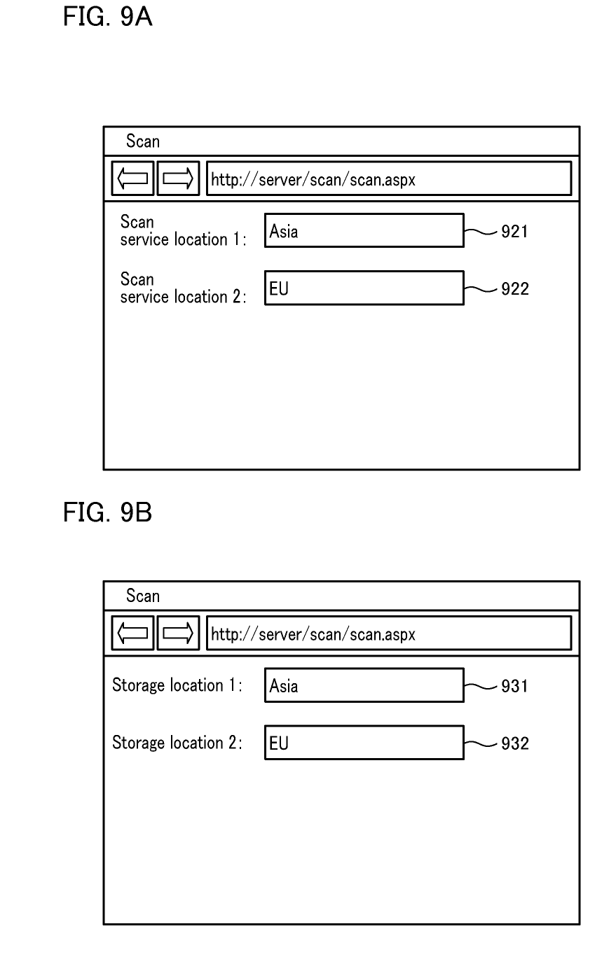

Another scan service selection button 912 is a button such that depression thereof causes the screen to transit another scan service selection screen shown in FIG. 9A. Also, a storage location 913 corresponds to the storage location information included in the job information acquired by the request reception unit 401. In this example, the storage location 913 displays Asia. Another storage selection button 914 is a button such that depression thereof causes the screen to transit another storage selection screen shown in FIG. 9B.

FIG. 9A is a diagram illustrating an example of another scan service selection screen. A scan application that operates in the request reception unit 401 generates another scan service selection screen. Scan service locations 921 and 922 indicate selectable execution locations (locations of the scan system). A user can select the location of the scan system in which document processing is executed on another scan service selection screen. When a user selects the location of the scan system, a service location ID for identifying the location of the scan system is selected. Then, the screen returns to the confirmation screen shown in FIG. 8B.

FIG. 9B is a diagram illustrating an example of another storage selection screen. A scan application that operates in the request reception unit 401 generates another storage selection screen. Storage locations 931 and 932 indicate selectable storage locations (locations of storage). A user can select the location of the storage in which print data is stored on another scan service selection screen. When a user selects the location of storage, a storage location ID for identifying the location of the storage is selected. Then, the screen returns to the confirmation screen shown in FIG. 8B.

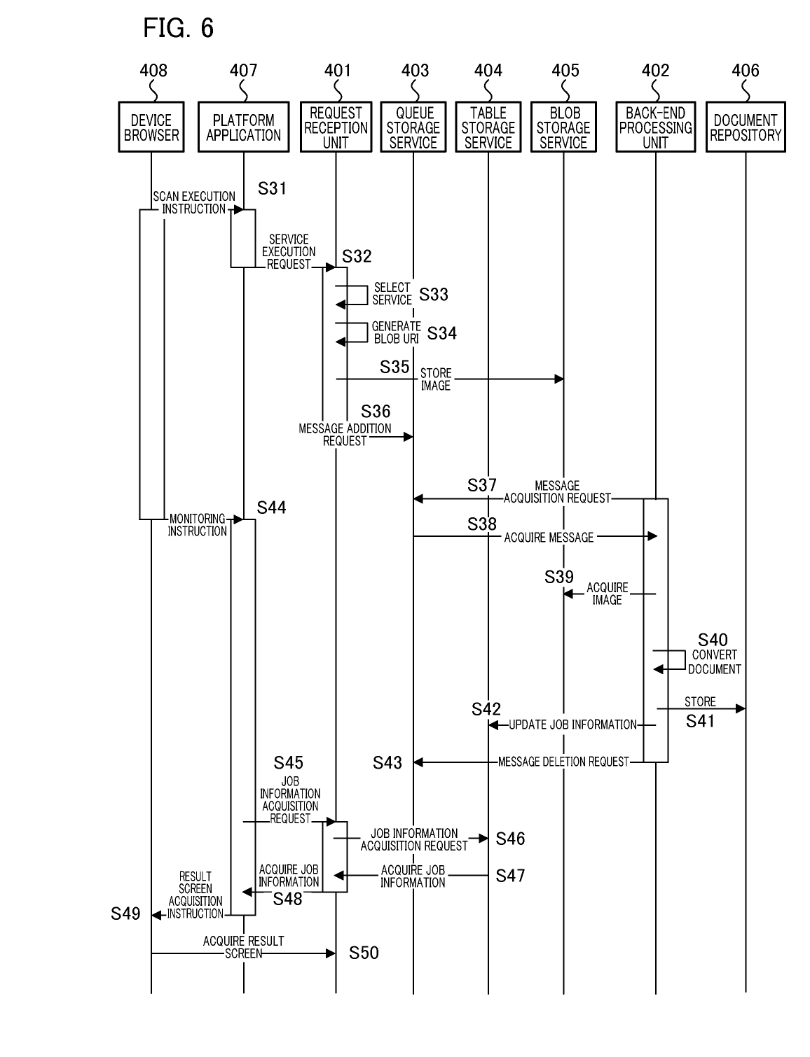

FIG. 6 is a sequence diagram illustrating the flow of scan execution processing performed by the system of the first embodiment. When a user pushes the continue button 915 on the confirmation screen shown in FIG. 8B, the device browser 408 provides a scan execution instruction to the platform application 407 (step S31). The scan execution instruction is an instruction that is provided to the platform application 407 and causes it to transmit a service execution request to the request reception unit 401. The scan execution instruction includes a document name, a device ID, a processing ID, a service location ID, and a storage location ID as parameters. The document name, the device ID, and the processing ID are information that has been selected on the screen shown in FIG. 8A. The service location ID and the storage location ID are information that has been selected on the screens shown in FIGS. 8B to 9B. In this example, the service location ID and the storage location ID correspond to the scan system 105 provided in the EU and the storage 106 provided in the EU, respectively.

Next, the platform application 407 makes a service execution request to the request reception unit 401 (step S32). The service execution request includes a document name, a device ID, a processing ID, a service location ID, a storage location ID, and image data. The image data is image data that is temporarily stored in the indirect storage unit 206 by the platform application 407 in step S2 shown in FIG. 5.

Next, the request reception unit 401 refers to the service table (see FIG. 4A), and specifies the service to be executed (step S33). More specifically, the request reception unit 401 selects a service that corresponds to the processing ID included in the service execution request. Among the selected services, the request reception unit 401 specifies a service corresponding to the service location ID and a scan system for executing the service. In other words, among the selected services, the request reception unit 401 specifies a service, in which the Queue URI matches the service location ID, as the service to be executed. The request reception unit 401 recognizes a scan system, which corresponds to the Queue URI that matches the service location ID, as a scan system for executing the specified service (document processing). In the example shown in FIG. 4A, the services that correspond to the processing ID of PDF conversion are the service of the first row and the service of the second row in the service table. The service of the first row corresponds to the scan system 105 provided in the EU. The service of the second row corresponds to the scan system 105 provided in Asia. Thus, the service location ID matches the Queue URI corresponding to the service of the first row. With this arrangement, the request reception unit 401 recognizes the scan system 105 as the scan system for executing document processing. Also, the request reception unit 401 specifies a service corresponding to the scan system 105 as the service to be executed. In step S33, the request reception unit 401 further refers to the job table (see FIG. 3B), and acquires the job ID included in job information corresponding to the specified service.

Next, the request reception unit 401 generates a blob URI (step S34). The blob URI corresponds to the blob storage service 405 of the scan system (the scan system 105), which has been recognized in step S33, for executing a service. Next, the request reception unit 401 makes a request including the blob URI to the blob storage service 405 of the scan system 105 such that an image is stored in the generated blob URI (step S35). Also, the request reception unit 401 makes a message addition request to the queue storage service 403 of the scan system 105 (step S36). The message addition request includes the blob URI that has been generated in step S34, and the document name and the storage location ID included in the service execution request that has been received in step S32. The message addition request also includes the job ID that has been acquired by the request reception unit 401 in step S33. The message addition request further includes the message ID that corresponds to the message type “scan service execution”. The queue storage service 403 performs message addition processing for adding a message to a queue in accordance with the message addition request.

The back-end processing unit 402 makes a message acquisition request to the queue storage service 403 at a regular interval (step S37). Then, the back-end processing unit 402 acquires the message stored in a queue from the queue storage service 403 (step S38). The back-end processing unit 402 recognizes the message type that is indicated by the message ID included in the acquired message. When the recognized message type indicates scan service execution, the back-end processing unit 402 acquires a blob URI, a document name, and a storage location ID from the message. Then, the back-end processing unit 402 accesses the acquired blob URI, and acquires image data (step S39).

The back-end processing unit 402 performs document conversion processing for the acquired image data (step S40). More specifically, the back-end processing unit 402 converts image data such as bit map or the like into a PDF format to thereby generate print data. Next, the back-end processing unit 402 stores the generated print data in the document repository 406 (step S41). More specifically, the back-end processing unit 402 refers to the storage table (see FIG. 4B), and recognizes storage corresponding to the Storage URL that matches the storage location ID acquired in step S38. In this example, the back-end processing unit 402 recognizes the storage 106 provided in the EU. The back-end processing unit 402 stores print data in the document repository 406 provided in the recognized storage. The back-end processing unit 402 specifies the document name acquired as a parameter in step S38 when print data is stored. The document repository 406 stores print data under the specified document name.

Next, the back-end processing unit 402 provides instructions to the table storage service 404, and updates job information (step S42). More specifically, the back-end processing unit 402 sets the Status of job information corresponding to the processed job to “Success”. Next, the back-end processing unit 402 makes a message deletion request to the queue storage service 403 (step S43). The message deletion request includes a message ID. With this arrangement, a message corresponding to the job that has currently been processed is deleted from a queue, whereby re-execution processing caused by a timeout is not performed.

On the other hand, the device browser 408 provides a monitoring instruction to the platform application 407 (step S44). The monitoring instruction includes a job ID as a parameter. Next, the platform application 407 makes a job information acquisition request to the request reception unit 401 (step S45). The job information acquisition request includes a job ID and a device ID as parameters. The request reception unit 401 makes a job information acquisition request to the table storage service 404 (step S46). The request reception unit 401 specifies the job ID, which is included in the job information acquisition request received from the platform application 407 in step S44, as an argument of the job information acquisition request and passes it to the table storage service 404. The table storage service 404 searches the job information that matches the job ID specified from the job table, and responds with the job information to the request reception unit 401 (step S47). Next, the request reception unit 401 refers to the Status of job information, and determines whether the job status is in the “Processing” or “Completion” state. In the present embodiment, the job status at the moment when the request reception unit 401 has received a response from the table storage service 404 in step S47 is in the “Completion” state. The request reception unit 401 transmits job information to the platform application 407 (step S48). The platform application 407 confirms that the job is in the “Completion” state based on job information. Then, the platform application 407 provides a result screen acquisition instruction to the device browser 408. In this example, the result screen indicates that the execution of a document processing job has been successful. The device browser 408 acquires the result screen from the request reception unit 401, and displays it on the screen (step S50). Note that the request reception unit 401 may pass the Storage URL corresponding to storage in which print data is stored to the device browser 408, so that the device browser 408 may display the Storage URL on the result screen. The image forming apparatus 102 can access the Storage URL displayed on the result screen to thereby acquire print data.

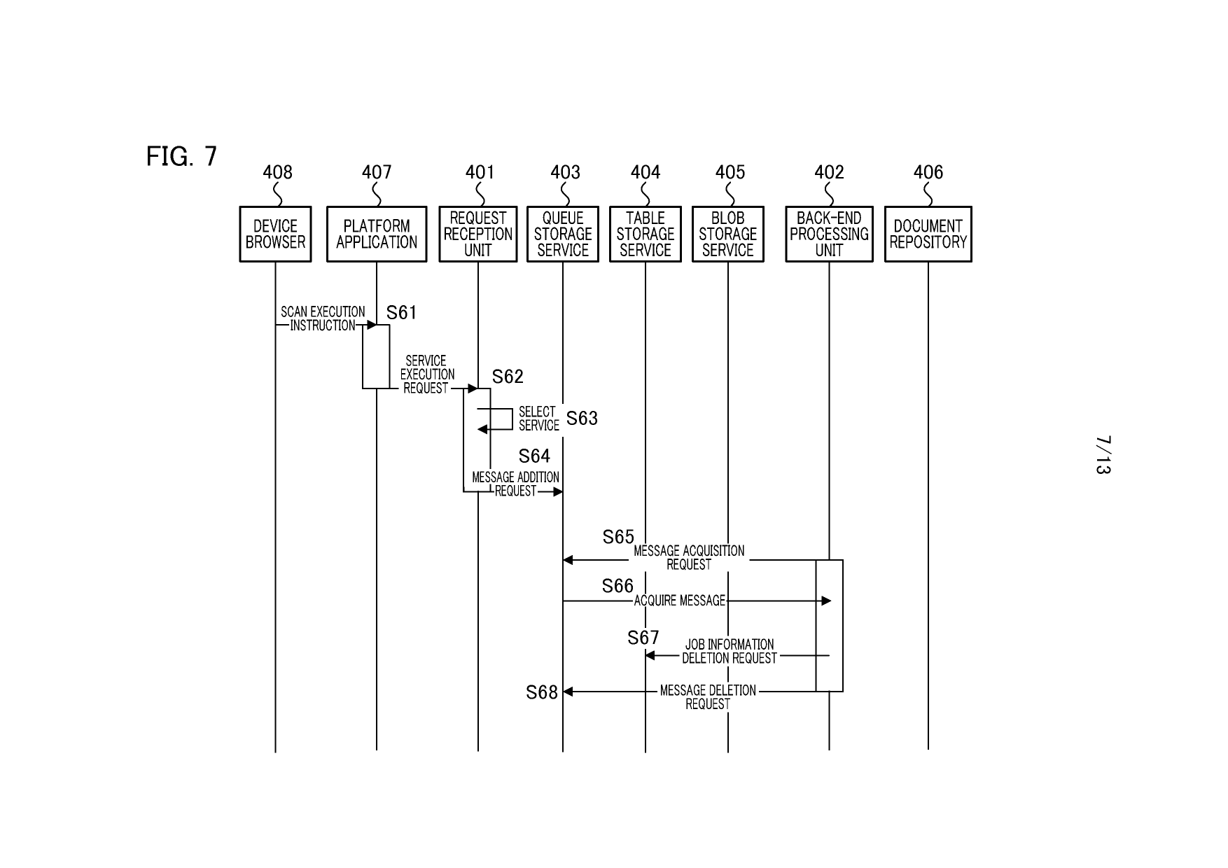

FIG. 7 is a sequence diagram illustrating the flow of scan canceling processing performed by the system of the first embodiment. Scan canceling processing is processing for deleting job information corresponding to a job not to be executed. Steps S61 and S62 shown in FIG. 7 are the same as steps S31 and S32 shown in FIG. 6, respectively. The request reception unit 401 recognizes a job not to be executed (step S63). In step S33 shown in FIG. 6, among the services in the service table, the request reception unit 401 specifies a service, which corresponds to the scan system 105 provided in the EU, as the service to be executed. Thus, the request reception unit 401 recognizes a job of a service that has not been specified as the service to be executed, that is, a service that corresponds to the scan system 103 provided in Asia as a job not to be executed.

The request reception unit 401 makes a message addition request to the queue storage service 403 of the scan system 103 (step S64). The message addition request includes a job ID that corresponds to a job not to be executed and a message ID that corresponds to the message type “scan service cancel” as parameters. The queue storage service 403 performs message addition processing in accordance with the message addition request (step S64).

The back-end processing unit 402 makes a message acquisition request to the queue storage service 403 at a regular interval (step S65). Then, the back-end processing unit 402 acquires a message from the queue storage service 403 (step S66). When the message type of the message ID included in the acquired message is “scan service cancel”, the back-end processing unit 402 takes a job ID from the message. Then, the back-end processing unit 402 makes a job information deletion request to the table storage service 404 (step S67). The job information deletion request is a request for deleting job information. The job information deletion request includes the job ID that has been acquired in step S66. The table storage service 404 deletes job information that corresponds to the job ID included in the job information deletion request (step S67). Also, the back-end processing unit 402 makes a message deletion request to the queue storage service 403 (step S68). The message deletion request includes a message ID that corresponds to the currently processed message. With this arrangement, the processed message is deleted from a queue, whereby re-execution processing caused by a timeout is not performed.

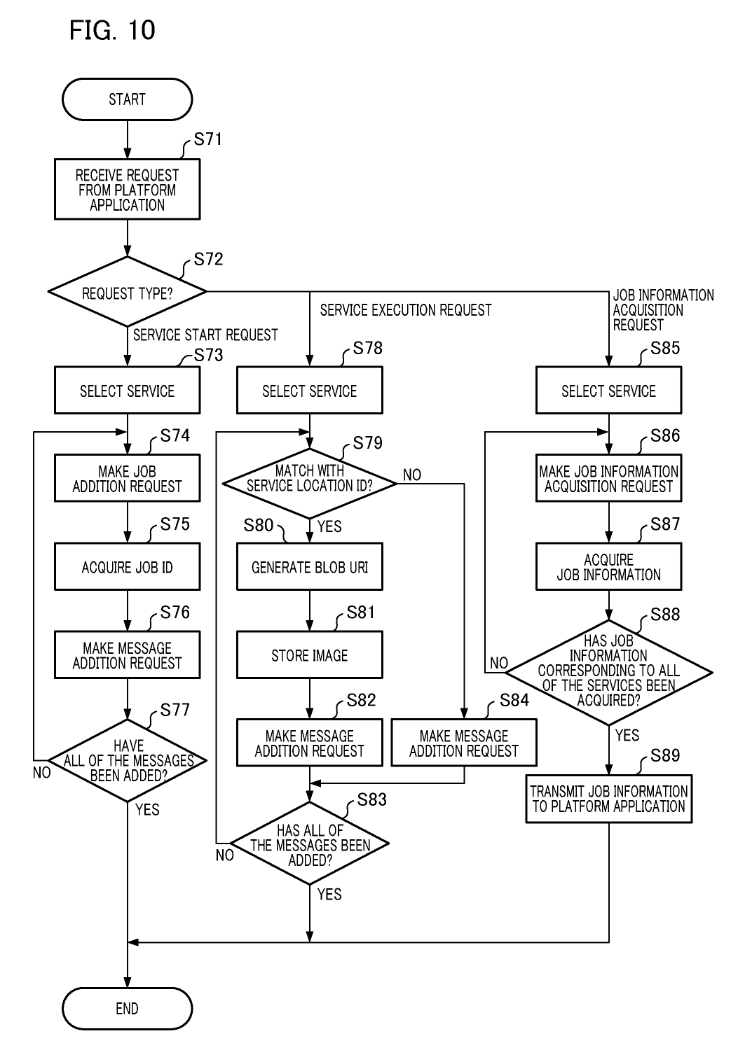

FIG. 10 is a flowchart illustrating an example of operation processing performed by a request reception unit. The request reception unit 401 receives a request from the platform application 407 (step S71). The request reception unit 401 determines the type of the request (step S72). When the request type is “service start request”, the request reception unit 401 refers to the service table, and selects a service that corresponds to a processing ID included in the service start request (step S73). Next, the request reception unit 401 makes a job addition request to the table storage service 404 (step S74).

Next, the request reception unit 401 acquires a job ID from the table storage service 404 as a response to the job addition request (step S75). Then, the request reception unit 401 makes a message addition request to the queue storage service 403 (step S76). With this arrangement, a message corresponding to the job ID is stored in a queue. Next, the request reception unit 401 determines whether or not all of the messages that correspond to the job of the service selected in step S73 have been added (step S77). When all of the messages that correspond to the job of the selected service have been added, the process is ended. When there is a message that is failed to be added, the process returns to step S74.

When the request type is “service execution request”, the request reception unit 401 refers to the service table, and selects a service that corresponds to a processing ID included in the service execution request (step S78). Next, the request reception unit 401 refers to the service table, and determines whether or not the Queue URI corresponding to the selected service matches the service location ID included in the service execution request (step S79). When the Queue URI corresponding to the selected service does not match the service location ID included in the service execution request, the request reception unit 401 makes a message addition request for deleting the job of the service to the queue storage service 403 (step S84). Then, the process advances to step S83.

On the other hand, when the Queue URI corresponding to the selected service matches the service location ID included in the service execution request, the request reception unit 401 generates a blob URI (step S80). Then, the request reception unit 401 provides an instruction to the blob storage service 405 to store an image in the blob URI (step S81). Then, the request reception unit 401 makes a message addition request to the queue storage service 403 (step S82). Next, the request reception unit 401 determines whether or not all of the messages that correspond to the job of the selected service have been added (step S83). When all of the messages that correspond to the job of the selected service have been added, the process is ended. When there is a message that has failed to be added, the process returns to step S79.

When the request type is “job information acquisition request”, the request reception unit 401 refers to the service table, and selects the service that corresponds to the processing ID (step S85). Next, the request reception unit 401 makes a job information acquisition request for acquiring the job information corresponding to the selected service to the table storage service 404 (step S86). Then, the request reception unit 401 acquires job information from the table storage service 404 (step S87). Next, the request reception unit 401 determines whether or not the job information corresponding to all of the services has been acquired (step S88). When the request reception unit 401 determines that the corresponding job information has not been acquired, the process returns to step S86. On the other hand, when the request reception unit 401 determines that the job information corresponding to all of the services has been acquired, the request reception unit 401 transmits job information to the platform application (step S89), and the process is ended.

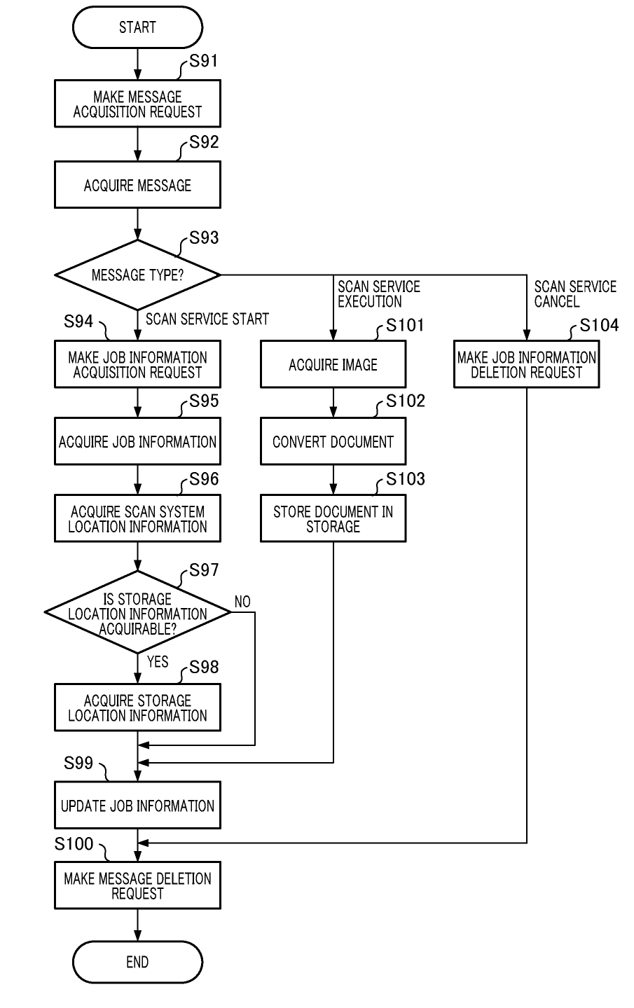

FIG. 11 is a flowchart illustrating an example of operation processing performed by a back-end processing unit. The back-end processing unit 402 makes a message acquisition request to the queue storage service 403 at a regular interval (step S91). The back-end processing unit 402 acquires a message from the queue storage service 403 (step S92). Then, the back-end processing unit 402 determines the message type based on the message ID included in the message (step S93).

When the message type is “scan service start”, the back-end processing unit 402 makes a job information acquisition request to the queue storage service 403 (step S94). Then, the back-end processing unit 402 acquires job information from the queue storage service 403 (step S95). Next, the back-end processing unit 402 acquires scan system location information using the service API for acquiring execution location information (in this example, location information about scan system).

Next, the back-end processing unit 402 refers to the storage table, and confirms the presence/absence of a service API for acquiring storage location information (in this example, location information about storage) (step S97). When a service API for acquiring storage location information is absent, the process advances to step S99. On the other hand, when a service API for acquiring storage location information is present, the back-end processing unit 402 acquires storage location information from the service API (step S98).

Next, the back-end processing unit 402 provides an instruction to the table storage service 404 and causes it to update job information (step S100). Then, the back-end processing unit 402 makes a message deletion request to the queue storage service 403 (step S100), and the process is ended.

When the message type is “scan service execution”, the back-end processing unit 402 acquires image data from the blob storage service 405 (step S101). Then, the back-end processing unit 402 performs document conversion processing for the acquired image data to thereby generate print data (step S102). Next, the back-end processing unit 402 refers to the storage table, selects the storage corresponding to the Storage URL that matches the storage ID included in the message, and stores print data in the selected storage (step S103). Then, the process advances to step S99. When the message type is “scan service cancel”, the back-end processing unit 402 makes a job information deletion request to the table storage service 404 (step S104), and the process advances to step S100.

According to the first embodiment, before the image forming apparatus 102 transmits an execution request for a document processing job to the request reception unit 401, the back-end processing unit 402 executes the following processing. The back-end processing unit 402 acquires information indicating a location at which the execution result of a document processing job is stored, and information indicating a location at which a storage system (the back-end processing unit 402 thereof) for executing the document processing job is arranged. Then, the request reception unit 401 generates screen information for displaying information indicating a location at which the execution result of the acquired job is stored and information indicating a location at which a storage system for executing the job is arranged on the image forming apparatus 102. Thus, according to the first embodiment, for example, a user confirms the scan system location and the storage location, and then can utilize the scan system. With this arrangement, a user can utilize the scan system and storage in a country or a region where document processing and document processing result storage are not legally restricted.

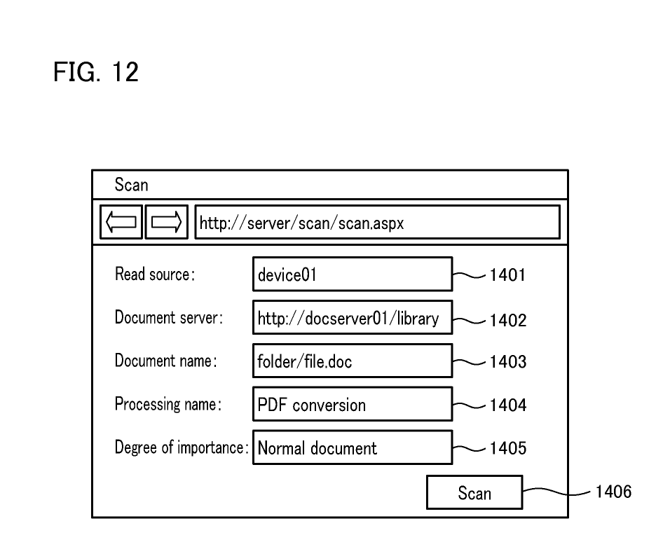

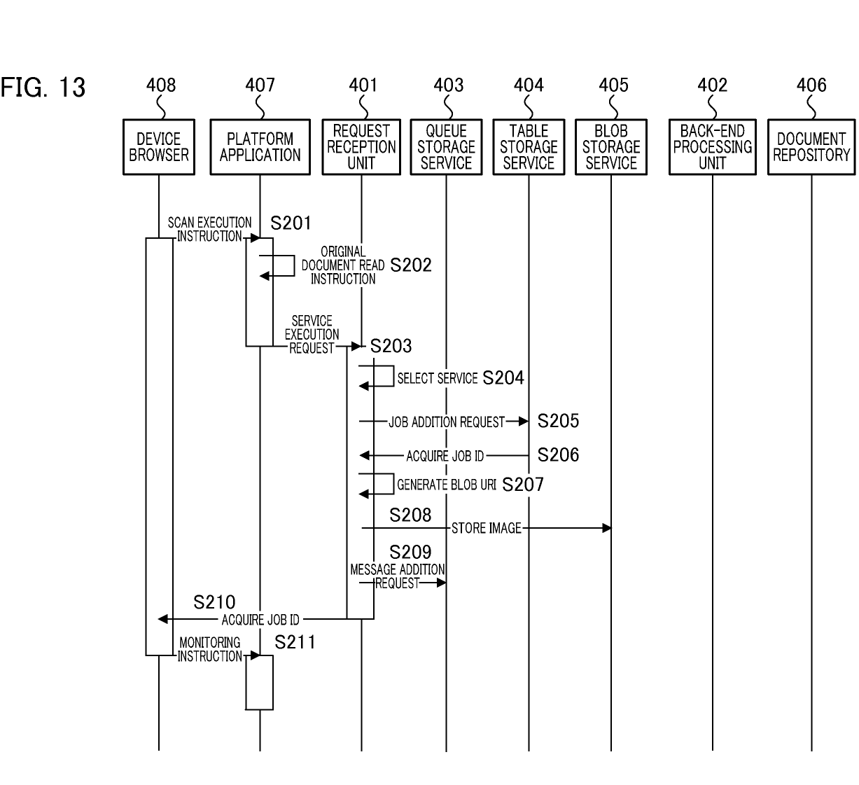

A description will be given below of a second embodiment with reference to FIGS. 12 and 13. In the first embodiment, when a document processing system starts a scan service, the scan system location and the storage location are always displayed on the image forming apparatus 102. However, when a document is not a confidential document, a user may not need to confirm the scan system location and the storage location. In the second embodiment, the degree of importance of the document is set upon start of a scan service by a user. Then, the document processing system displays the scan system location and the storage location on the image forming apparatus 102 only when a document is a confidential document.

FIG. 12 is a diagram illustrating an example of a start screen to be displayed on the device browser 408. Scan application that operates in the request reception unit 401 generates the screen. A read source 1401 is the same as the read source 901 shown in FIG. 8A. A document server 1402 is the same as the document server 902 shown in FIG. 8A. A document name 1403 is the same as the document name 903 shown in FIG. 8A. A processing name 1404 is the same as the processing name 904 shown in FIG. 8A. A degree of importance 1405 indicates the degree of importance of the document. The image forming apparatus 102 inputs the degree of importance in accordance with a user's operation. A user may input the degree of importance of various documents, such as a confidential document, a regular document, or the like. For example, when a user inputs a confidential document, the processing sequence is the same as that described in the first embodiment. In the second embodiment, a user sets “regular document” as the degree of importance of the document. In other words, when the degree of importance of the document to be subject to document processing set by the image forming apparatus 102 is a first degree of importance, the back-end processing unit 402 acquires information indicating a location at which the execution result of a document processing job is stored. When the degree of importance of the document to be subject to document processing is a second degree of importance of which the degree of importance is lower than the first degree of importance, the back-end processing unit 402 does not acquire information indicating a location at which the execution result of a document processing job is stored.

FIG. 13 is a sequence diagram illustrating document processing of the second embodiment. When the degree of importance is set to “regular document” on the start screen shown in FIG. 12 and a scan button 1406 is pushed, the device browser 408 provides a scan execution instruction to the platform application 407 (step S201). The scan execution instruction includes a document name, a device ID, and a processing ID as parameters. The document name, the device ID, and the processing ID are information set in the start screen shown in FIG. 12.

Next, the platform application 407 provides an original document read instruction to the image forming apparatus 102 (step S202) and receives the image data that has been read by the image forming apparatus 102. Next, the platform application 407 makes a service execution request to the request reception unit 401 (step S203). The service execution request includes image data, a document name, a device ID, and a processing ID.

Next, the request reception unit 401 refers to the service table, selects a service corresponding to the processing ID, and specifies the scan system that executes the selected service (step S204). When a plurality of services corresponding to the processing ID is present, the request reception unit 401 executes the scan system that executes a service arbitrarily selected from the plurality of services. In the present embodiment, it is assumed that the request reception unit 401 has specified the scan system 103 provided in Asia.

The request reception unit 401 makes a job addition request to the table storage service 404 of the scan system 103 (step S205). The table storage service 404 performs job generation processing, and returns the ID of the generated job to the request reception unit 401 (step S206).

Next, the request reception unit 401 generates a blob URI (step S207). Then, the request reception unit 401 provides an instruction to the blob storage service 405 of the scan system 103 such that an image is stored in the blob URI that has been generated in step S207 (step S208). Also, the request reception unit 401 makes a message addition request to the queue storage service 403 of the scan system 103 (step S209). The message addition request includes a job ID, a blob URI, and a document name. The message addition request also includes a message ID that corresponds to the message type “scan service execution”. The queue storage service 403 performs message addition processing in response to the message addition request.

The processes in steps S210 and S211 are the same as those in steps S8 and S17 shown in FIG. 5, respectively.

According to the second embodiment, a user can set the degree of importance of the document upon start of a scan service, and confirm the scan system location and the storage location only when the degree of importance of the set document is a confidential document. With this arrangement, for a document having a low degree of importance, a user can utilize the scan system without considering the scan system location and the storage location.

According to the cloud computing system of the present invention described above, for example, a user can utilize the scan system after the user confirms the location of the scan system for executing document processing and the location of the storage for storing the execution result of document processing. With this arrangement, a user can utilize the scan system and storage in a country or a region where document processing and document processing result storage are not legally restricted.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims he benefit of Japanese Patent Application No. 2010-128401 filed Jun. 4, 2010, which is hereby incorporated by reference herein in its entirety.

What is claimed is:

1. A cloud computing system comprising:
a request reception unit that stores a message corresponding to a document processing job in a storage unit in response to the receipt of an execution request for the document processing job from an image forming apparatus; and
a document processing unit that makes an acquisition request for the message to the storage unit at a regular interval, acquires the message, and stores job data that corresponds to the acquired message;
wherein, before the image forming apparatus transmits an execution request for a document processing job to the request reception unit, the document processing unit acquires information indicating a location at which the job data is stored, and the request reception unit generates screen information for displaying information indicating the acquired location at which the job data is stored on the image forming apparatus.

2. The cloud computing system according to claim 1, wherein, before the image forming apparatus transmits an execution request for a document processing job to the request reception unit, the document processing unit acquires information indicating a location at which a document processing unit for executing the document processing job is provided, and the request reception unit causes the image forming apparatus to display the acquired information indicating a location at which a document processing unit for executing the document processing job is provided.

3. The cloud computing system according to claim 2, wherein, when the document processing unit is incapable of acquiring information indicating a location at which a document processing unit for executing the document processing job is provided, the request reception unit causes the image forming apparatus not to display information indicating a location at which a document processing unit for executing the document processing job is provided.

4. The cloud computing system according to claim 1, wherein, when the document processing unit is incapable of acquiring a location at which the job data is stored, the request reception unit causes the image forming apparatus not to display information indicating a location at which the job data is stored.

5. The cloud computing system according to claim 1, wherein the document processing unit acquires information indicating a location at which the job data is stored when the degree of importance of a document to be processed by document processing set by the image forming apparatus is a first degree of importance, and does not acquire information indicating a location at which the job data is stored when the degree of importance of a document to be processed by document processing is a second degree of importance of which the degree of importance is lower than the first degree of importance.

6. A document processing method comprising:
storing, in a request reception step, a message corresponding to a document processing job in a storage unit in response to the receipt of an execution request for the document processing job from an image forming apparatus; and
making, in a document processing step, an acquisition request for the message to the storage unit at a regular interval, acquiring the message, and storing job data that corresponds to the acquired message;
wherein, before the execution request for the document processing job is received from the image forming apparatus, the document processing step acquires information indicating a location at which the job data is stored, and the request reception step generates screen information for displaying information indicating a the acquired location at which the job data is stored on the image forming apparatus.

7. A computer readable storage medium on which is stored a computer program for making a computer execute a document processing method, the method comprising:
storing, in a request reception step, a message corresponding to a document processing job in a storage unit in response to the receipt of an execution request for the document processing job from an image forming apparatus; and
making, in a document processing step, an acquisition request for the message to the storage unit at a regular interval, acquiring the message, and storing job data that corresponds to the acquired message;
wherein, before the execution request for the document processing job is received from the image forming apparatus, the document processing step acquires information indicating a location at which the job data is stored, and the request reception step generates screen information for displaying information indicating the acquired location at which the job data is stored on the image forming apparatus.
